(19) United States
(12) Patent Application Publication
(10) Pub. No.: US 2012/0191819 A1
(43) Pub. Date: Jul. 26, 2012

(54) Universal remote control protocol transcoder

(75) Inventor: Mark Calomeni, San Jose, CA (US)

(73) Assignee: Mark Calomeni, San Jose, CA (US)

(21) Appl. No.: 13/374,884

(22) Filed: Jan. 20, 2012

Related U.S. Application Data
(60) Provisional application No. 61/461,652, filed on Jan. 21, 2011.

(51) Int. Cl. G06F 15/16

(52) U.S. Cl. 709/219

(57) ABSTRACT

The present invention relates to a method and system for transcoding any remote control protocol to any other remote control protocol comprising the steps of establishing a connection to a server proxy; converting in a bidirectional manner where the outputs from one or more remote control protocol form into the inputs of another remote control protocol and vice-verse for the duration of a session. The method may be performed by a transcoding server in order to increase the overall systems enablement.

### CROSS REFERENCE TO RELATED APPLICATIONS

This application claims priority under 35 U.S.C. §119 (e) to U.S. provisional patent application Ser. No. 61/461,652 filed on Jan. 21, 2011, the contents of which is hereby incorporated herein by reference in its entirety for all purposes.

### FIELD OF INVENTION

This invention relates to remote access systems that allow host computers to be accessed and controlled by client computer running heterogeneous remote control protocols via a network.

### BACKGROUND OF THE INVENTION

With the growing availability of high-speed internet access, the need for constant access to computer systems has become more demanding. A typical example is an office computer system that may have important applications, data, and network availability to secured systems not conveniently or even possibly available outside the office. Recent years have seen the rise of remote desktop or remote control protocols that display the remote computer's desktop on the screen of a local computer like a PC or a mobile computing device while allowing the user to control the remote computer using a local mouse and keyboard. The ultimate benefit is a remote computing experience that is identical or near identical to being directly logged into the remoted computer. The concept of what may be remoted has also grown and is not limited to typical remote control protocols. For example, a client may be enabled through a web browser running HTML, connecting to a web or application server which is itself connected to a remote computer acting as a client or server.

The typical remote control scheme works by enabling a computer with the server software of a particular remote control protocol to function as a “host” or “server”. A second computer, enabled with the client software of the same remote control protocol, can function as a client. The host/server directly accepts the connection from the client over a network such as the internet and after authentication and authorization, a remote session begins.

In order for this to work properly the client and server must be enabled with the same remote control protocol. An example of a scheme that will not work is where the server is running RDP (Microsoft) and the client is running RFB(VNC) (RealVNC). In many computing environments, there may be many different remote control protocols installed as a consequence of user preference or differing commitments to operating systems like MacOS, iOS, Windows, Linux, etc. Windows comes enabled with RDP but Linux may not, preventing a user of a Linux system from remoting the Windows computer.

At present, the prior art approach to solving this problem requires users to install multiple remote control server applications on the host/server and/or multiple remote control client applications on the client. Often one or more of these are commercial software applications requiring a license be purchased on a per-seat basis, or may not be available on the client OS in any form.

### SUMMARY OF THE INVENTION

In accordance with the principles of the invention, a network available component called a transcoder is enabled to act as a gateway between the client of one type of remote control protocol and a server of the same or another. Embodiments of the present invention are directed to a method and system for remote controlling a host computer from a client computer using heterogeneous remote control protocols operatively enabled through a remote control protocol transcoder.

Desktop information is generated from a host. A transcoding client capable of understanding a remote control protocol receives this information from the remote host and transcodes it to one or more other remote control protocols acting as clients, itself now acting as the server. Clients, any number of which, likely using a different remote control protocol than the original server, can now connect to the transcoding server and see the original remoted desktop.

One or more users intending to remote a target computer will function within a session enabling them to share transcoder resources in isolation with or jointly with other sessions. The transcoder functions as a means of taking the inputs of one remote control protocol and converting them to the output of a second and vice-versa. In one embodiment the transcoder is deployed in such a manner as to enable maximum scalability of its various functional parts distributed over a communications network yet operatively connected. In a second embodiment the transcoder and its functional parts are all installed on a single computing device. In yet another embodiment a plurality of transcoder systems are chained together.

The present invention works equally well where the host and client are traditional remote control protocols or remote desktop protocols or remote meeting protocols or HTTP where the client is a HTML client such as a web browser but are not limited as such.

### BRIEF DESCRIPTION OF THE DRAWINGS

FIG. 1 is an exemplary block diagram showing components of a typical prior art environment in which a typical remote control protocol environment operates.

FIG. 2 is an exemplary block diagram showing components of an environment in which the invention operates.

FIG. 2b is an exemplary representation of an alternative embodiment of the system in accordance with the invention.

FIG. 3 is an exemplary block diagram illustrating the logical architecture of the transcoder in accordance with the invention.

FIG. 4 is an exemplary block diagram illustrating the transcoding server in accordance with the invention.

FIG. 5 is a block diagram illustrating the embodiment of the invention.

FIG. 6 is an exemplary flow chart illustrating a first embodiment of a method in accordance with the invention.

### DETAILED DESCRIPTION OF THE INVENTION

Reference will now be made in detail to the present invention, examples of which are illustrated in the accompanying drawings. Wherever possible, the same reference numbers will be used throughout the drawings to refer to the same or like parts.

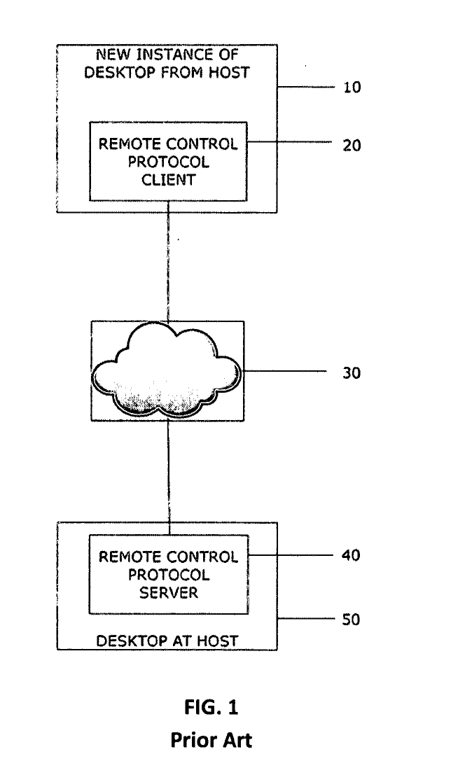

FIG. 1 is an exemplary block diagram showing components of a typical prior art environment in which a typical remote control protocol environment operates. A computing device 10 includes any computer that is compatible with the execution requirements of the remote control client protocol. The remote control client software 20 is installed on 10 and sends and receives information to and from the remote control server over 30 a communications network. The remote control server software 40 is installed on 50 and sends and receives information to and from a remote control client over 30. A computing device 50 includes any computer that is compatible with the execution requirements of the remote control server protocol. The client 20 and the server 40 use the same remote control protocol to communicate, albeit the client uses the client version and the server uses the server version of the same protocol. In such a scheme, there are two steps necessary for the client 20 and the server 40 to communicate. Step 1 is the session setup process where the client provides protocol specific information, such as but not limited to user name, display parameters, local resource usage, and user experience settings to the server. The server then performs an authentication and authorization function which if successful, initiates step 2, session creation. The desktop of 50 will now be remoted to 10.

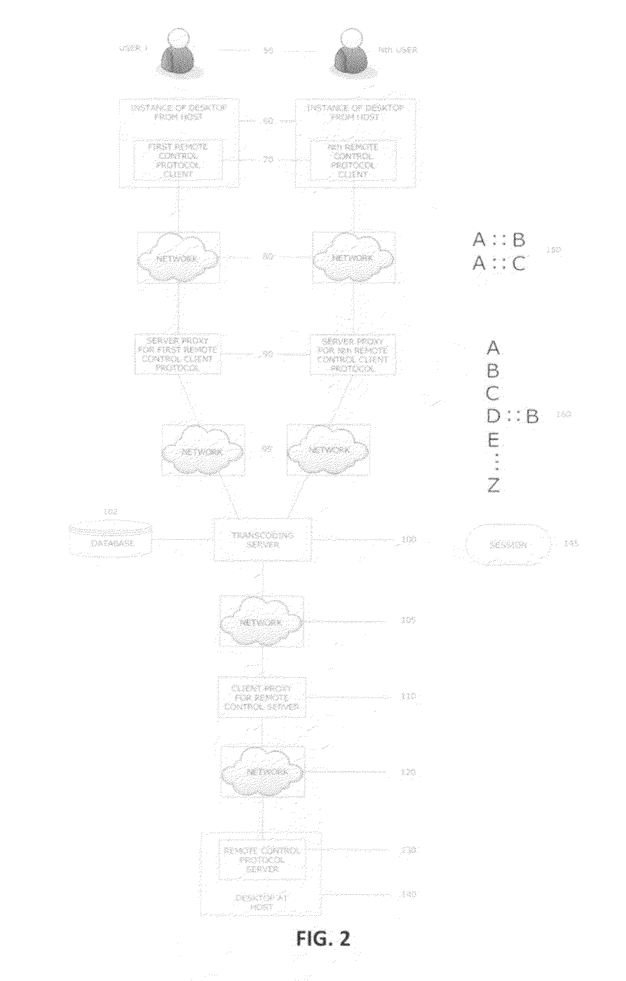

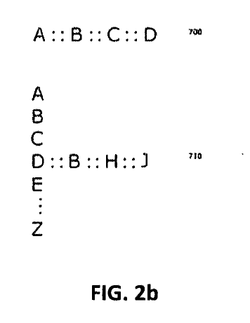

FIG. 2 is an exemplary block diagram illustrating an embodiment of a system in accordance with the invention. A session shall be defined as a semi-permanent interactive information interchange between two or more computing devices, or between a computer and user. A session is set up or established at a certain point in time, and torn down at a later point in time. An established session may involve sending and receiving of more than one message in each direction. A session is typically, but not limited to, stateful, meaning that at least one of the communicating parts needs to save information about the session history in order to operate, as opposed to stateless communication, where the communication consists of independent requests with responses.

A user 55 is may comprise a singular person operating a computing device 60 or a group of users 55 operating a plurality of computing devices 60 jointly participating in the remoting of the target computing device 140. Within the session 145 all steps performed by the invention are done in isolation of others sessions that are concurrently in operation between 60 and 140.

A computing device 60 is operated by a user 55. The computing device may be but not limited to a mobile communications device, a thin-client, a desktop computer or a server and is equipped with the client remote control software 70. An example of the client remote control software comprise HTML, WebEX, RDP, VNC, ICA, rdesktop and PCoIP but is not limited in this respect. The user 55 will attempt to connect to the target computer 140 over a communications network 80 with the intent of remoting the desktop of the target computing device 140 or to perform some other remote control or sharing function from the source computing device. The communications networks 80, 95, 105 and 120 may be part of an internet, intranet and may comprise networks of different types such as but not limited to GSM, GPRS, UMTS/3G, CDMA, PCS, Ethernet or WLAN and my use protocols TCP/IP, TCP, UDP, DCCP, SCTP, RSVP and ECN but is not limited in this respect.

The server proxy 90 is an enablement that functions as, but is not limited to, the server-side specification of the particular remote control protocol 70 installed on 60. The server proxy 90 is functionally equivalent and operatively enabled to behave as the server of the particular remote control protocol 70. In essence, remote control protocol 70 believes it is directly remoting the target desktop 140. The server proxy 90 may be enabled as pure software or as a computing appliance. In this embodiment, the server proxy 90 and the transcoder 100 are logically divided into a multitude of functions possibly running on distinct computing devices for scalability. The server proxy 90 is operatively connected to the computing device 60 via the client software of the remote control protocol 70 over a communications network 80.

In an embodiment of the invention, the server proxy 90 is operatively connected to the transcoder 100 over an optional communications network 95. In another embodiment, the server proxy 90 and the transcoder 100 may be located on the same computing device not separated by a communications network 95.

The transcoding server 100 is enabled to manage the client connections of one or more simultaneous server proxies 90 in a homogeneous or heterogeneous configuration with respect to the types of remote control protocols running on the computing devices 60. The transcoding server 100 is further enabled to create, retrieve, update, delete and publish information regarding active sessions underway or planned for the future. Information regarding scheduling and participants is stored in a database 102 operatively connected to transcoder 100.

The transcoding server 100 operatively converts the outputs of remote control protocol A into the inputs of remote control protocol B and vice-versa. This is annotated by the notation A::B 150. In yet another embodiment, the transcoder 100 may be enabled singularly in a hardware or software product, or as an alternative embodiment, collectively as a combined product. The transcoder may be enabled as a dedicated service to user 55 or it may be a shared service where unrelated users may share it over either the Internet or an Intranet. The embodiments of the invention may include various steps. The steps may be embodied in machine-executable instructions which may be used to cause a general-purpose or special-purpose processor to perform the steps. Alternatively, and as another embodiment, these steps may be performed by specific hardware components that contain hardwired logic for performing the steps, or by any combination of programmed computer components and custom hardware components.

A typical usage scenario involves two steps. In step 1, user 55 directs the remote client protocol (type A) to connect to the server proxy (type A) to start the session setup process where the client provides protocol specific information, such as but not limited to destination, user name, display parameters, local resource usage, and user experience settings to the server. The server proxy (type A) then operatively communicates to the transcoding server 100 which directs a client proxy 110 (type B) to authenticate and authorize user 55 in the remote control protocol of the target server 130 (type B). If successful, step 2 is a session 145 is created and user 55 will remote the desktop of 140 transparently spanning two remote control protocols as noted A::B. When a multitude of simultaneous or concurrent users are attempting to remote a single target within a given session the following notation 160 may be used:

$$\begin{matrix}\begin{matrix}\begin{matrix}\begin{matrix}\begin{matrix}\begin{matrix}A \\ B\end{matrix} \\ C\end{matrix} \\ D :: B\end{matrix} \\ E\end{matrix} \\ …\end{matrix} \\ Z\end{matrix}$$

FIG. 2b is an exemplary representation of an alternative embodiment of the system in accordance with the invention. The system is arranged to perform a daisy-chaining of transcoding servers 700. Further represented is the embodiment where a plurality of simultaneous or concurrent clients are daisy-chained to the ultimate server to be remoted 710.

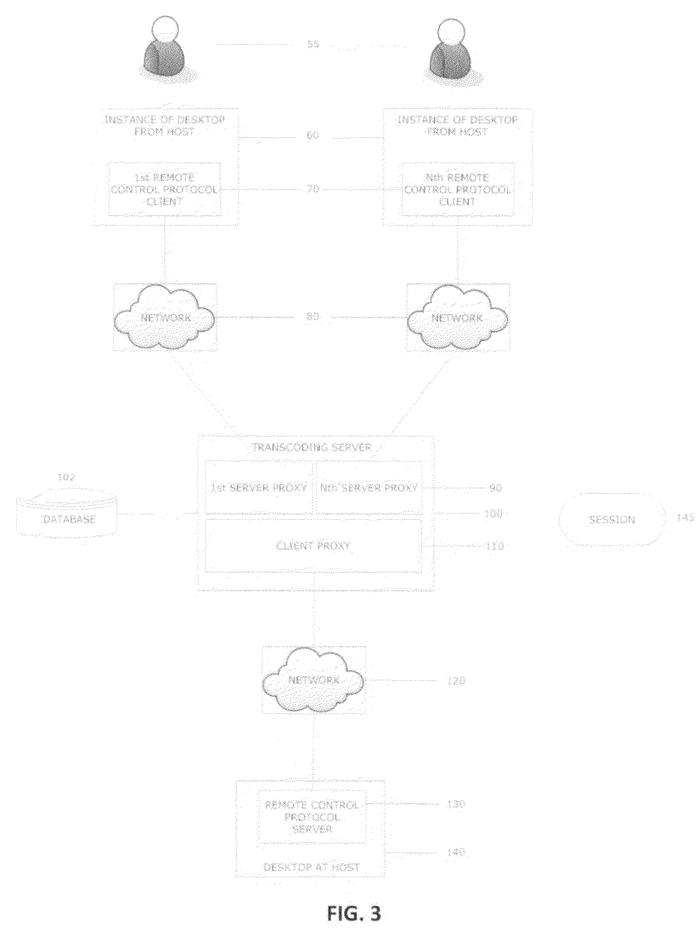

FIG. 3 is an exemplary block diagram illustrating an alternative embodiment of the system in accordance with the invention. The system is arranged to perform a method according to the invention, such as one of the embodiments being described in detail below with reference to FIG. 2, 4, 5 or 6.

The transcoding server 100 is arranged to perform the functions of the server proxy 90 and the client proxy 110 within the same computing device eliminating the need for a network connection between the server proxy 90 and the transcoding server 100 and the transcoding server 100 and the client proxy 110.

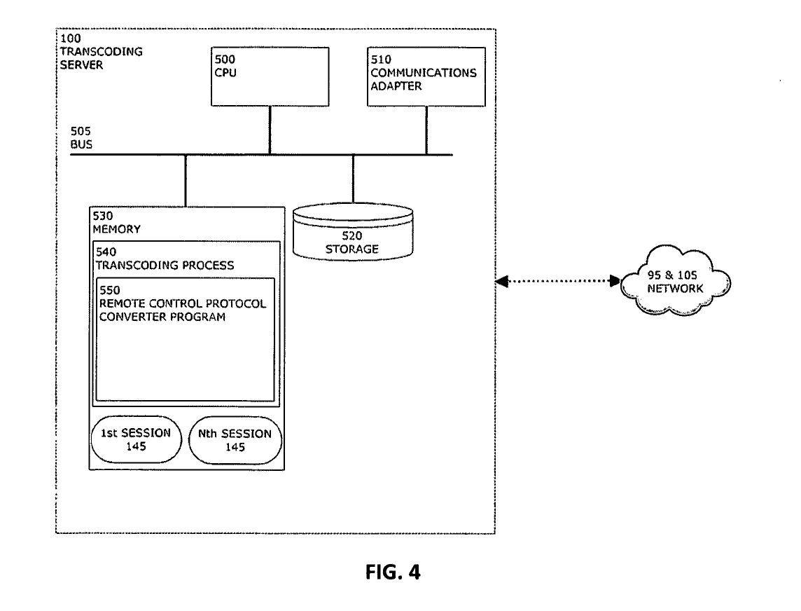

FIG. 4 is a block diagram illustrating an exemplary transcoder server 100 comprising an internal bus 505 which interconnects one or more central processing devices 500 arranged to execute instructions embodied in a computer program retained in either volatile or non-volatile memory 530, also interconnected to the internal bus 505.

The transcoding process 540 is arranged to perform a method according to the invention, such as one of the embodiments being described in detail below with reference to FIG. 2, 3, 5 or 6. The bus 505 is also connected to a data storage device 520, such as but limited to a magnetic medium, for non-volatile storage of programs and/or data.

The bus 505 is also connected to a communication adapter 510 that enables communication between the client terminal and the networks 95 and 105. The communications adapter may be a high bandwidth network adapter for connecting to a data processing network, the Internet, an Intranet, a personal area network (PAN), etc.

In addition, the transcoding server may comprise additional devices (not illustrated), operatively connected to the internal bus 505. Such additional devices include an output device such as a display adapter, which is further connected to a display, and an input adapter, which is connected to input devices such as a keyboard and a pointer device.

The computer program in the memory 530 particularly comprises a transcoding process 540. The transcoding process 540 particularly comprises a computer program 550 for converting the output requirements from a remote control protocol client into the input requirements of a remote control protocol server and the output requirements of the remote control protocol server into the input requirements the remote control protocol client.

The transcoding process 540 further comprises computer program portions for operatively allowing a plurality of remote control protocol clients to operate with a single remote control protocol server within a single session 145 with the possibility of a plurality of sessions 145.

In an exemplary embodiment, the memory 530 further optionally comprises one or more server proxies 90 to allow remote control protocol clients 70 to operatively connect and to satisfy the server side of the client's remote control protocol. In addition, the memory 530 optionally comprises one or more client proxies 110 to allow remote control protocol servers 130 to operatively connect and to satisfy the client side of the server's remote control protocol.

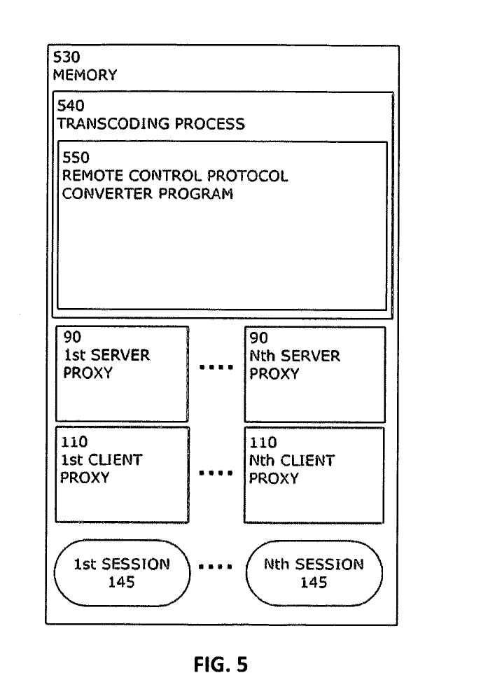

FIG. 5 is a block diagram illustrating an alternative embodiment of the computer program in the memory 530. The computer program in the memory 530 particularly comprises a transcoding process 540. The computer program 550 is as described above and referenced in FIG. 4.

The memory 530 further comprises a plurality of server proxies 90, a minimum of one for each of the remote control client protocol types connecting to the transcoding server 100.

The memory 530 further comprises a plurality of client proxies 110, a minimum of one for each of the remote control server protocol types to be transcoded by the transcoding server 100.

The memory 530 further comprises a plurality of sessions 145 to maintain client to host connection state.

Exemplary methods for implementing the transcoder 100 are described. These exemplary methods may be described in the context of computer executable instructions. Computer executable instructions can include routines, programs, components, data structures, procedures, modules, functions, or equivalent that perform particular operations or implement particular data types. These operations may also be performed in a distributed computed environment with computer executable instructions being located either within an internet, intranet or both.

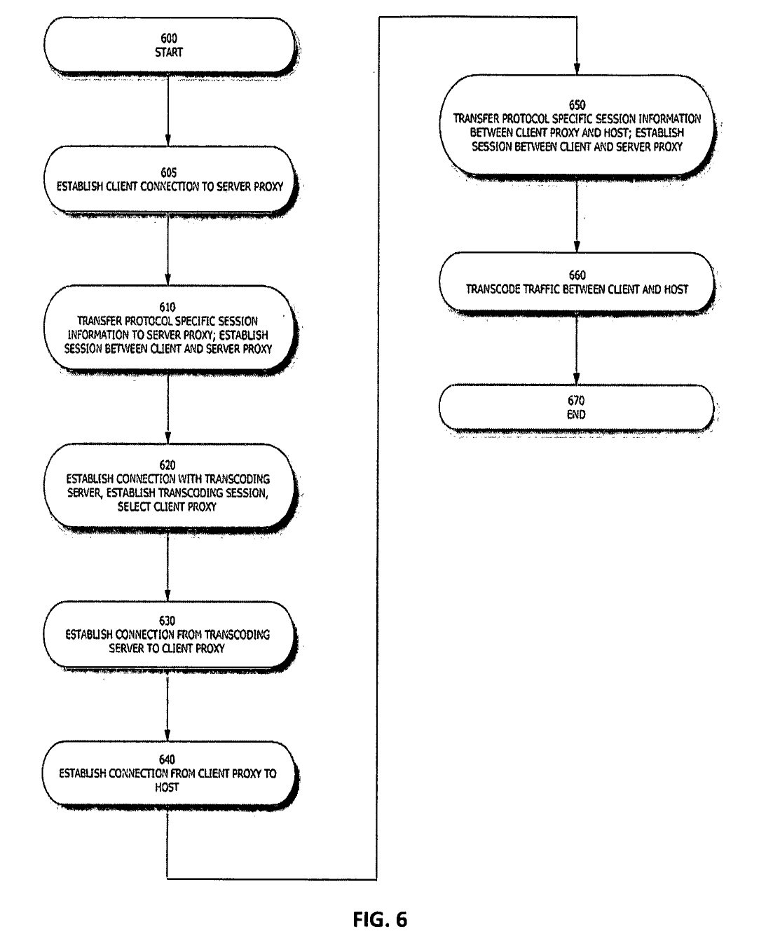

FIG. 6 is an exemplary flow chart illustrating an embodiment of a method in accordance with the invention. Consistent with the invention the method may be performed by the transcoding server 100 illustrated by example in FIGS. 2, 2b, 3, 4, and 5. The method starts with the initial step 600.

In this embodiment of the method it is assumed that the transcoding server 100 has been properly configured with information about computers, operating systems, networks, domain names, users, escalations or any other information technology systems administration settings required in the environment for which it is installed although the invention is not limited in this respect. The transcoding server may function on an operating system such as Linux, Solaris, Mac OS, iOS, or Windows, but is not limited to such specifications.

Next, in step 605, a user 55 operating the computing device 60 running a first remote control protocol 70 will attempt to connect to computing device 140 over various network configurations exemplified by 80, 95, 105 and 120. Through proper administrative configuration discussed above, the client will establish a connection to the server proxy 90 which will be recognized in accordance with the specifications required by the first remote control protocol 70. Information required to establish a connection according to the client 70 is provided by user 55 or preinstalled on 60 and may be in the form of, but not limited to, dialog menus, command-line arguments or program constants and/or transformed from any prior transcoding information declaration.

Next, in step 610, the client will transfer to, and the server proxy 90 will operatively accept the afore mentioned information required to establish a connection and maintain the client connection from the first remote control protocol 70 and act as a server in accordance to the server specification governing of the first remote control protocol 70. Step 610 may be repeated by the server proxy one or more times for a plurality of computing devices 60 running the first remote control protocol 70. The server proxy 90 will accept and manage information related to access, authentication, and authorization but is not limited to such functionality in the form of a session specific to the remote control protocol client 70 and server proxy 90.

Next, in step 620, the server proxy will operatively establish and maintain a connection with the transcoding server 100. Information regarding, but not limited to, the desired host 140, the requesting client 60, the user 55 and access, authentication, and authorization credentials, may be operatively given to the transcoding server to complete the process. The transcoding server 100 may operatively accept and maintain one or more simultaneous connections from a plurality of server proxies 90. The establishment of a connection between a server proxy 90 and the transcoding server 100 may be on-demand in that there is no previously known information regarding the user 55 and a desire to connect to computing device 140. Session 145 is established at the time user 55 initiates the connection to 140. As an alternative embodiment, the requirement to connect to computing device 140 may be known ahead of time and information related to such, be persisted to a database and activated when user 55 initiated the connection to 140. The requirements afore mentioned may also include a plurality of user information and session preferences such as email notification options, reminder options, a session password or conference call details, but is not limited to such. The transcoding server will convert session establishment information passed to it by the server proxy 90 relative to the client remote control protocol 70 into session establishment information relative to the host remote control protocol 130, passing it to the proper client proxy.

Next, in step 630, the transcoding server 100 will operatively establish and maintain a single connection over a communications network 105 with the client proxy 110 for a session 145. It is expected that for a given host 140, only one connection from the client proxy 110 will be in operation at any given time for a session 145 although client proxy can maintain a plurality of sessions simultaneously to different hosts.

Next, in step 640, the client proxy 110 will operatively establish and maintain a single connection over a communications network 120 for a given session 145 to the target computing device 140 running a second remote communications protocol 130. The second remote control protocol may be different than the first remote control protocol but is not limited to such. The client proxy will function in accordance with the client-side requirements of the remote control protocol 130 on the host computing device 140.

Next, in step 650, the transcoder 100 will opera

Next, in step 660, the transcoder 100 will operatively convert in a bidirectional manner, outputs from the first remote control protocol 70 into inputs of the second remote control protocol 130 and vice-verse for the duration of session 145.

Next, in step 670, the process ends with the termination of session 145.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

What is claimed is:

1. (canceled)

2. A machine-implemented method for remote controlling a host computing device from a client computing device where the host and the client are using homogeneous or heterogeneous remote control protocols, comprising the ordered steps:
(a) establishing a first connection, the first connection being between the first remote control protocol client to a server proxy specifically enabled to act as the server for the first remote control protocol client;
(b) after the first connection is established, transferring protocol specific first session establishment information through the first connection to enable the system to initiate a remote session to the host;
(c) after transferring protocol specific first session establishment information, establishing a session between the client and the server proxy according to the specifications of the first remote control protocol;
(d) after a session between the client and the server proxy is established, establishing a second connection between the server proxy and the transcoding server;
(e) after the second connection is established, establishing a transcoding session to maintain state for the overall connection between the host and the client and transferring first session establishment information through the second connection from the server proxy to the transcoding server enabling the transcoding server to identify the proper client proxy;
(f) after the transcoding session is established, converting first session establishment information relative to the first remote control protocol into second session establishment information relative to the second remote control protocol;
(g) after second session establishment information has been converted, selecting a client proxy by the transcoding server, the client proxy being operatively enabled to act as the client for the second remote control protocol used by the host;
(h) after selecting the client proxy, establishing a third connection between the transcoding server and the client proxy;
(i) after the third connection is established, transferring second session establishment information through the third connection to enable the client proxy to establish a session with the host;
(j) after the second session establishment information is transferred, establishing a forth connection between the client proxy and the host;
(k) after the forth connection is established, transferring second protocol specific session establishment information through the forth connection to enable the client proxy to initiate a session to the host;
(l) after transferring second protocol specific session establishment information, establishing a session between the client proxy and the host according to the specifications of the second remote control protocol;
(m) after establishing a session between the client proxy and the host, transcoding traffic between the client and the host by operatively converting in a bidirectional manner, outputs from the first remote control protocol into inputs of the second remote control protocol and vice-verse for the duration of the transcoding session.
